(19) United States
(12) Patent Application Publication
(10) Pub. No.: US 2014/0377066 A1
(43) Pub. Date: Dec. 25, 2014

(54) Portable Self-Inflating Airborne Wind Turbine System

(71) Applicant: Alexander Anatoliy Anderson, North Bend, WA (US)

(72) Inventor: Alexander Anatoliy Anderson, North Bend, WA (US)

(21) Appl. No.: 13/926,073

(22) Filed: Jun. 25, 2013

(51) Int. Cl. F03D 1/06; F03D 11/00

(52) U.S. Cl. CPC F03D 1/065; F03D 11/0033
USPC 416/44; 416/84; 416/31

(57) ABSTRACT

A portable airborne wind-energy power conversion system, alone or in a modular array, wherein each portable airborne system comprises tethered airship, hydrogen generation system, hydrogen recovery system, and control system, wherein the tethered airship comprises a self-inflating horizontal-axis wind turbine rotor, an electrical generator, a self-inflating aerodynamic shroud surrounding the wind turbine rotor, and stabilizing fins, wherein the aerodynamic shroud has the geometry of a wind concentrator and diffuser in fluid communication with the wind turbine rotor that is located in the narrowest section of the shroud between the concentrator and diffuser sections of said shroud, wherein the airship is additionally self-deflating and the entire system is collapsible into a volume less than one tenth of its original size, so that the portable airborne system can be easily transported, stored, or relocated, wherein the system can continue to produce usable power, even during the process of self-deflation.

U.S. PATENT DOCUMENTS.

| | | |
|---|---|---|
| 8,395,276 | March 2013 | Freda |
| 8,393,850 | March 2013 | Werle, et al. |
| 8,350,403 | January 2013 | Carroll |
| 8,308,918 | November 2012 | Gil, et al |
| 8,268,030 | September 2012 | Abramov |
| 8,253,265 | August 2012 | Glass |
| 8,246,796 | August 2012 | Eikhoff |
| 8,202,668 | June 2012 | Chiu |
| 8,178,990 | May 2012 | Freda |
| 8,109,711 | February 2012 | Blumer, et al |
| 8,089,173 | January 2012 | Freda |
| 8,082,748 | December 2011 | Matsuo, et al |
| 7,939,960 | May 2011 | Kim |
| 7,938,623 | May 2011 | Cairo |
| 7,830,033 | November 2010 | Meller |
| 7,804,186 | September 2010 | Freda |
| 7,786,610 | August 2010 | Potter |
| 7,709,973 | May 2010 | Meller |
| 7,723,861 | May 2010 | Meller |
| 7,615,138 | November 2009 | Davidson |
| 7,602,077 | October 2009 | Ferguson |
| 7,582,981 | September 2009 | Meller |
| 7,335,000 | February 2008 | Ferguson |
| 7,317,261 | January 2008 | Rolt |
| 7,129,596 | October 2006 | Macedo |
| 7,218,011 | May 2007 | Hiel, et al. |
| 7,109,598 | September 2006 | Roberts |
| 7,008,711 | March 2006 | Pondo, et al |
| 6,890,410 | May 2005 | Sullivan |
| 6,781,254 | August 2004 | Roberts |
| 6,766,982 | July 2004 | Drucker |
| 4,491,739 | January 1985 | Watson |
| 4,450,364 | May 1984 | Benoit |
| 4,433,552 | February 1984 | Smith |
| 4,350,897 | September 1982 | Benoit |
| 4,350,896 | September 1982 | Benoit |
| 4,309,006 | January 1982 | Biscomb |
| 4,207,026 | June 1980 | Kushto |
| 4,166,596 | September 1979 | Mouton, Jr. et al. |
| 4,073,516 | February 1978 | Kling |
| 3,954,236 | May 1976 | Brown |
| 3,924,827 | December 1975 | Lois |
| 2,433,344 | December 1947 | Crosby |
| 2,384,893 | September 1945 | Crook |
| 1,717,552 | June 1929 | Dunn |
| 1,172,932 | February 1916 | Bucknam |
| 2008/0048453 | February 2008 | Amick |
| 2010/0032947 | February 2010 | Bevirt |
| 2011/0049992 | March 2011 | Sant'Anselmo; Robert; et al. |

FOREIGN PATENT DOCUMENTS

| | | |
|---|---|---|
| 0045202 | February 1982 | EP |
| 1929152 | June 2008 | EP |
| 0935068 | August 1999 | EP |
| 2005007506 | March 2009 | WO |
| 2007076837 | July 2007 | WO |
| 2010145664 | December 2010 | WO |
| 2008131719 | November 2008 | WO |

### FIELD OF THE INVENTION

The present invention relates to the conversion of wind energy into other forms of energy, such as electrical energy, by implementing a portable self-inflating airborne wind turbine system.

### BACKGROUND OF THE INVENTION

Conventional wind turbine designs, typically employing two-bladed or three-bladed open-rotor turbine blades, have been used successfully for many years, but present a few inherent drawbacks. These include impracticality in low wind regions, large installation and maintenance costs, noise pollution, and negative environmental impacts, especially bird and bat deaths. Firstly, conventional wind turbines are impractical in low wind regions, such as suburban regions or regions with large trees or other obstructions, since the power output of a turbine increases by the cube of the wind velocity and any reduction in wind velocity implies a significant drop in the performance of the electric generation system. Secondly, nearly all conventional wind turbine designs have to be mounted on a steel and concrete tower with a complicated system to control the speed of the turbine and to yaw the turbine into the oncoming wind. Additionally, such wind turbines require a complex control system to feather the wind turbine blades out of the wind during storms. Furthermore, conventional wind turbines are often damaged by lightning strikes since the blades extend hundreds of feet into the air. Thirdly, conventional wind turbines produce large amounts of aerodynamic noise, which increases with the speed of the tip of the turbine blade, and hence, the diameter of the blades. As a result of the aerodynamic noise and other low-frequency vibrations, people living near large wind turbines often complain about chronic headaches, migraines, nausea, dizziness, sleep disturbance, stress, and anxiety. Finally, it is often difficult for birds and bats to detect wind turbine blades rotating at high rotational speeds, and so they fly into the arc swept by the turbine blades and are struck and killed by the turbine blades that rotate at speeds in excess of 200 mph.

Aerodynamic shrouds consisting of a wind concentrator and a diffuser have been successfully used on wind turbines for several years due to the increase in efficiency and the reduction of aerodynamic noise by shielding the wind turbine rotor from the outside atmosphere. Many such shrouds have been patented in recent years with different aerodynamic enhancements, such as U.S. Pat. Nos. 8,089,173; 8,317,469; 7,256,512; 4,422,820; 8,395,276; and 4,075,500. Such shrouds increase the difficulty and cost of installation significantly since the wind concentrator and diffuser require additional support structure and impose further aerodynamic loads on the support tower. Therefore, although the use of such flow modules increases the performance of horizontal axis wind turbines, the added expense of constructing such concentrator-diffuser-augmented wind turbines typically do not make such designs cost-effective.

Since the speed of the wind increases as a power function of the height above terrain, the power output, and hence cost-effectiveness of wind turbines increases with the height of the tower used to support the turbine. However, there is a limit to the height that conventional steel structures can reach (currently around 80 meters). As a result wind turbine designers have turned to alternate designs involving airborne turbines, such as those designed by Altaeros Energy (U.S. Pat. No. 8,253,265) or Makani Power (multiple patents). Their methods comprise mounting the wind turbines on an unmanned air vehicle such as a dirigible, sailplane, flying wing, etc. However, these designs also have various problems inherent to their design. Firstly, the designs employing a turbine that is supported by a lift-producing wing, such as patent 2010/0032947 require a significant oncoming wind in order to lift the wind turbine to the desired altitude. Without sufficient wind at ground level, the assembly will not generate enough lift to raise the wind turbine off the ground.

Secondly, the blimp designs described by patents such as U.S. Pat. No. 8,253,265; 7,786,610; and 4,350,897 can lift themselves into the air without the need for a strong wind at ground level. However, their designs implement a lighter-than-air gas that will over time effuse into the atmosphere, limiting the amount of time the airship can spend before it sinks back to ground level due to insufficient gas. Additionally such designs have no method of recharging the dirigible with additional lighter-than-air gas while it is in flight. Thus, the dirigible would need to be periodically retracted and recharged with lighter-than-air gas that would need to be transported to the wind site, thus increasing the maintenance expenses significantly due to the high cost of helium or other helium-hydrogen gas mixtures.

Additionally, prior art airborne wind turbines mention the hazards posed by lightning to conventional wind turbines, but prior art, the majority of the time, does not propose any methods of protecting airborne turbines from lightning strikes, even though airborne turbines are at a much higher risk due to their greater altitude.

Although foreign patent 2008131719 does feature a hydrogen electrolysis system, the electrolysis device is on board the blimp with a high-pressure water pump to pump the necessary water to the blimp. These features add significantly to the weight and cost of the assembly. Furthermore, the wind turbine described in patent 2008131719 is not portable. Indeed, nearly all prior art are not portable, such that the wind turbine device is compact and lightweight enough such that the assembly can be used to generate power for hikers in remote locations, military units seeking high-efficiency portable renewable energy sources, regions without electrical grid connection, or consumers seeking to reduce their carbon footprint.

Finally, foreign patent 2008131719 does not feature a method to recapture the hydrogen used to fill the airship when the blimp is deflated for transportation. Indeed, 2008131719 does not even mention a system that could be used to deflate the wind turbine, while U.S. Pat. No. 4,309,006 simply vents the generated hydrogen gas into the atmosphere. The latter method implies that all the electrical power that was used to generate the hydrogen used to inflate the dirigible is wasted every time the blimp is re-inflated, which leads a significant decrease in the overall efficiency of the design.

### SUMMARY OF THE INVENTION

The present invention addresses all the problems inherent to the designs of prior art, including performance in low wind speeds, large maintenance costs, noise pollution, environmental impacts, and portability.

The present invention comprises a system in which a horizontal axis wind turbine is supported by a tethered dirigible that is filled with lighter-than-air gas, in which the internal pressure of the blimp and the elevation of the wind turbine are controlled by a control system, as shown and described herein. The blimp is a thin-walled aerodynamic shroud whose geometry is that of a high-efficiency concentrator-diffuser wind turbine, namely a volume of revolution with an airfoil cross-section. The horizontal axis wind turbine is connected to a gearbox that turns an electric generator powering the control system and the desired loads. The assembly also includes a system to prevent damage to the assembly from static discharge and lightning strikes through the use of metallic film coatings, static discharge ports, and grounding wires.

The control system features a feedback system that controls the internal pressure of the airship, such that when the pressure of the lighter-than-air gas drops below a certain level due to effusion, the control system activates a electrolysis system that generates hydrogen gas and refills the blimp. The hydrogen generation system is mounted in the ground station, thereby presenting two advantages. Firstly, since the condenser, electrolysis system, and compressor are located on the ground, the hydrogen-filled shroud only has to support the weight of the gearbox and electric generator, thereby reducing the required volume of the shroud and thus, the cost. Secondly, since the compressor only needs to pump hydrogen gas to the blimp, the system requires far less energy than if it were to pump water, which requires a far greater pressure head. Likewise, if the pressure inside the airship exceeds a predetermined maximum, the feedback control system activates the hydrogen recovery system, which would deflate the airship back to the desired internal pressure. The hydrogen recovery system is also mounted in the ground station and uses the same compressor of the hydrogen generation system to pump the hydrogen from the airship. The gas is then recombined with oxygen from the ambient air to produce useful power.

Additionally, the current invention also includes another feedback control system that controls the altitude of the airship. The control system allows the airship to rise until the wind turbine rotor reaches a predetermined minimum angular velocity. However, if the rotational speed of the wind turbine rotor exceeds a predetermined maximum because of excessive wind speeds, the control system retracts the tether until the blimp reaches a lower altitude, and so lower wind speeds. Finally, the control system also features a feed-forward system such that if severe weather is predicted aloft, the user-activated control system would retract the blimp to ground level to minimize possible damage to the assembly. Furthermore, if severe weather is forecast both at altitude and at ground level, the control system would retract the wind turbine to ground level and fully deflate the airship.

Finally, when the user wishes to transport the wind turbine, the control system would fully retract and deflate the turbine using the hydrogen recovery system, thus recapturing the energy used to generate the hydrogen to inflate the shroud and allowing the system to continue to power the desired loads, even while the turbine is being deflated for transportation.

The present invention presents the following advantages: It can be launched in a region with minimal wind at ground level since the system uses a lighter-than-air gas to lift the wind turbine to the desired altitude. It also avoids large maintenance costs due to the simplicity of its design and the self-filling feature of the blimp. Additionally, it significantly reduces noise pollution since the turbine is enclosed on all four sides. Furthermore, the design reduces the possibility of bird and bat deaths since a flying animal could only be struck in the unlikely case that it were to fly down the center of the blimp. Moreover, the present invention includes a control system designed to ensure maximum performance of the airborne wind turbine system, while protecting the system from any possible damage and recapturing the energy used to inflate the blimp. Finally, since the blimp has a minimal number of components and generates its own lighter-than-air gas, it is fairly lightweight, and so can be easily deflated, disassembled, transported, reassembled, and re-inflated.

### BRIEF DESCRIPTION OF THE DRAWINGS

FIG. 1 depicts the inflated wind turbine and shroud tethered to the ground station.

FIG. 2 depicts the shrouded turbine, its tethers, and the hydrogen supply line.

FIG. 3 depicts the side view of the shrouded turbine.

FIG. 4 depicts the front view of the shrouded turbine.

FIG. 5 depicts a cross-sectional view of the invention taken along a vertical plane passing through the axis of symmetry.

FIG. 6 depicts a cross-sectional view of the assembly taken along a horizontal plane passing through the axis of symmetry.

FIG. 7 depicts the horizontal and vertical planes along which the ¾ section view in FIG. 8 was taken.

FIG. 8 depicts a ¾ section view of the invention.

FIG. 9 depicts the inflatable wind turbine rotor (inflated)

FIG. 10 depicts a detail of the wind turbine rotor showing reinforcing structure.

FIG. 11 depicts the wind turbine rotor deflated for shipment (same scale as FIG. 9)

FIG. 12 depicts the hydrogen generation system.

FIG. 13 depicts the winch system used to control the length of each tether.

FIG. 14 depicts the hydrogen generation and recovery system. Arrows indicate airflow when the blimp is being inflated.

FIG. 15 depicts the hydrogen generation and recovery system. Arrows indicate airflow when the blimp is being deflated.

FIG. 16 depicts the portable airborne wind turbine system deployed in a modular array.

### DETAILED DESCRIPTION

The following description details an exemplary configuration of the present invention that may be embodied in many different geometries, forms, and configurations. Therefore, specific structural and functional details disclosed herein are not to be interpreted as limiting, but merely as a representative basis for the set of possible configurations of the present invention.

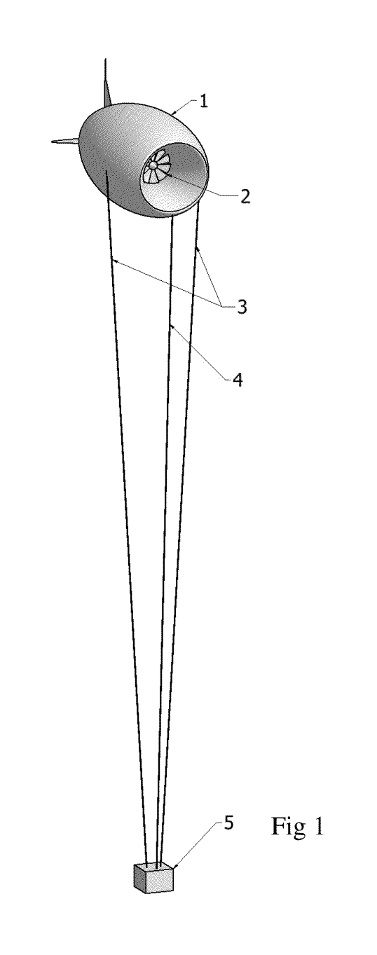

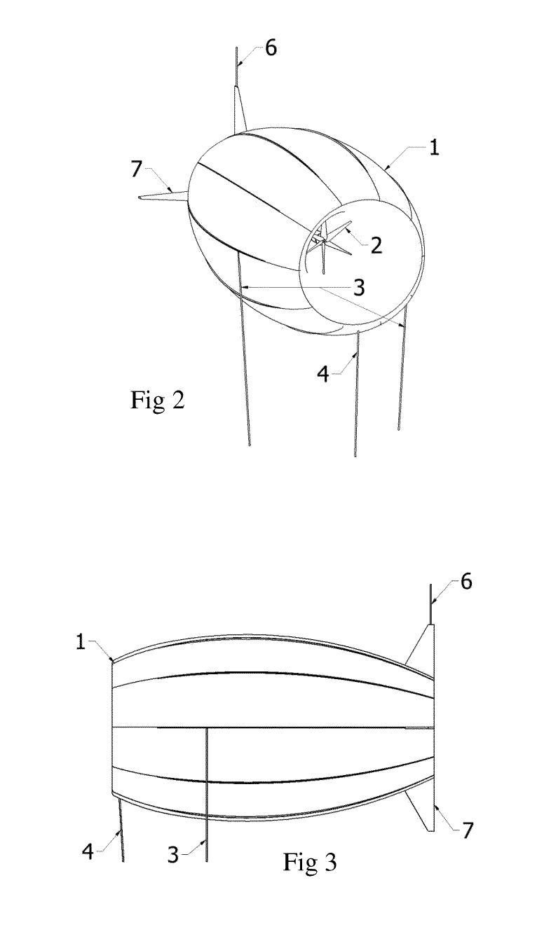

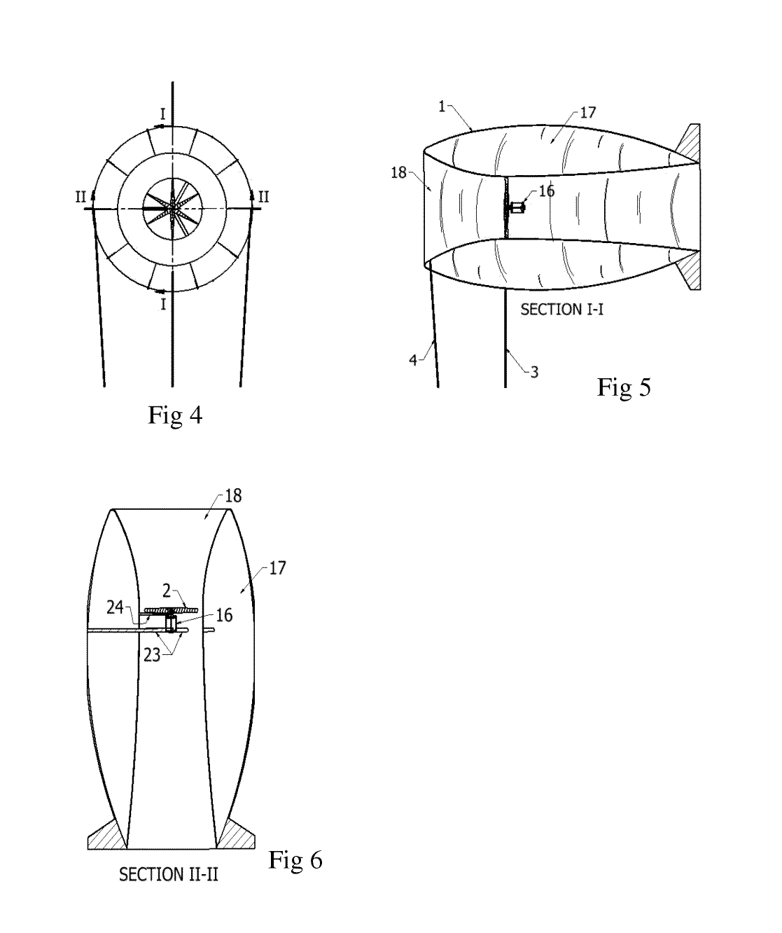

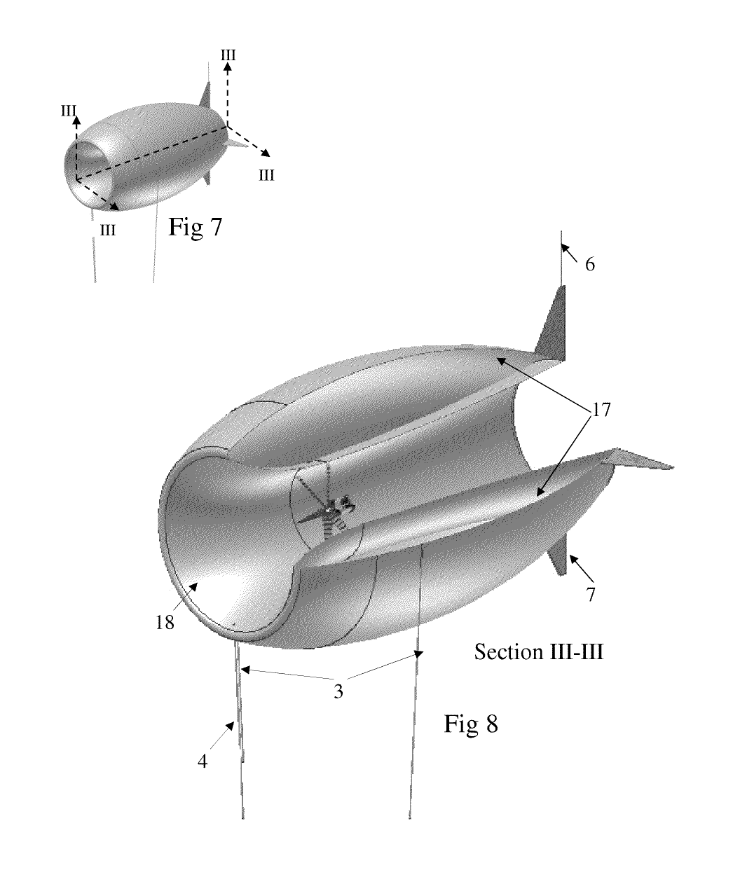

As depicted in FIG. 1, the present invention consists of the aerodynamic shroud 1 with the geometry of a wind concentrator-diffuser augmenter. The design consists of a venturi nozzle in fluid communication with a diffuser, such that the wind is accelerated as it passes through the flow module. Preferably, the shroud features an optimized geometry to maximize the airflow through the center of the blimp; such a geometry can be determined by either empirical or numerical analysis techniques. The aerodynamic shroud is filled with hydrogen gas so that it is buoyant and supports the weight of the other components of the assembly.

The wind turbine rotor 2 is mounted in the narrowest section of the throat of the flow module, such that the flow with highest possible airspeed passes over the turbine blades, thus maximizing the power output and, thus, the efficiency of the wind turbine. The wind turbine rotor is also filled with hydrogen gas such that it is buoyant, thus minimizing the weight of the blimp.

The wind turbine rotor 2 and the shroud 1 are both made of a resilient flexible material or set of materials so as to minimize effusion of the supporting gas from the assembly. The assembly could use a this polymer film (such as polyethylene, Mylar®, or any other similar material) to maintain the pressure of the assembly while using a high-strength woven fiber (Dacron®, Vectran®, Spectra®, Kevlar®, carbon fiber, or any other material suitable for the application) to maintain the shape of the shroud. Additionally, the inflated components could be coated with a UV resistant and/or abrasion resistant coating, such as Tedlar® to ensure the desired level of strength to maximize the lifetime of the present invention. Finally, to minimize the risk of accidents caused by static electricity, the internal and external surfaces of the shroud are coated with a thin metallic film, such as that commonly used in the electronics industry to protect integrated circuits form static discharge. The metallic films would then be connected to a ground wire and static discharge port(s) 6. The static discharge ports would also serve to protect the system from lightning strikes by providing a discharge path around the important components of the system.

The blimp, tethered to the ground station 5, is allowed to ascend to a high altitude in order to take advantage of the much higher wind velocities far above ground level and to avoid the wind gusts and turbulence, caused by terrain, that are detrimental to the performance of wind turbines. The blimp is tethered by side tethers 3 and a tether 4 located anywhere along the longitudinal axis of the dirigible. The side tethers serve dual roles. Firstly to enable the airship to float passively in the airstream, high above ground level, and secondly as the electrical conductors to pass the electricity generated to ground level. The electrical lines include, but are not limited to, one or more “hot” lines, a neutral line, and sensor wires relaying the rotational speed of the rotor and other parameters required by the control system.

The longitudinal tether 4 comprises of the ground wire for the airship and the hydrogen supply line for the system. The ground wire (not depicted) can be fixed to the earth at the ground station using a stake, auger, or other similar grounding rod. The hydrogen supply consists of a thin-walled tubing that can be made of any lightweight flexible material that is resistant to hydrogen.

The hydrogen supply line is connected to the hydrogen generation system to be described below at the ground station 5 and the inner volume of the shroud at the opposite end.

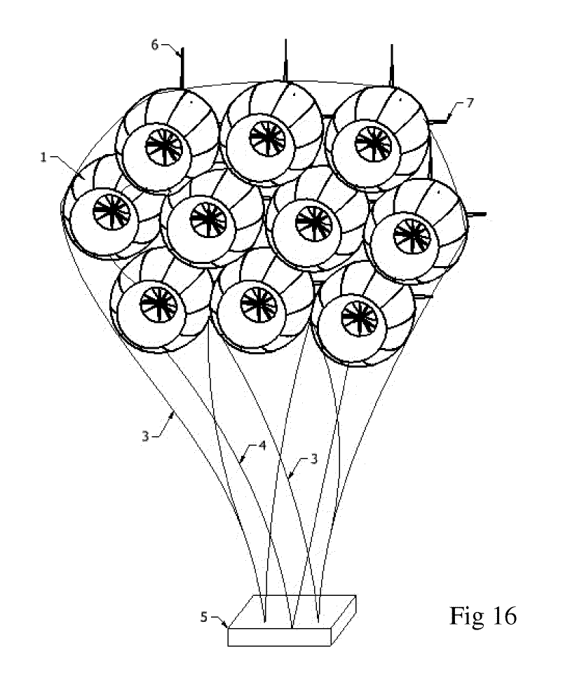

The blimp is directed into the oncoming wind by the combination of the greater surface area of diffuser portion of the airship 1 and the stabilizing fins 7, thereby allowing the wind turbine to the maximum advantage of the higher winds aloft. Additionally, to increase the performance of the system and to enable the designer to produce any desired power output, the present invention can be scaled or placed in a modular array, as depicted in FIG. 16.

FIG. 5 illustrates the internal and external surfaces of the shroud 1 and the other components of the dirigible. The wind turbine rotor 2 is connected to the electrical generator 16 either by means of a shaft and gearbox (industry standard) or any other suitable method, such as the rotor drum design described in U.S. Pat. No. 7,218,011. The electrical generator 16 may be synchronous or asynchronous AC 1-phase or 3-phase, DC, or any suitable electrical generator, as desired by the designer. However, a DC generator is preferred since most electronics, especially electrolysis units, operate off of direct current; using a direct current electric generator would thereby eliminate the need for an inverter, hence significantly reducing the size, weight, and cost of the present invention.

The internal region 17, bounded by the flow surface 18 and the outer surface of the airship, is filled with the lighter-than-air gas supplied by the longitudinal tether 4. Aforementioned, the flow surface 18 and outer surface preferably have the shape of an airfoil that is optimized to the size of the dirigible, maximizing the amount of air passing through the region bounded by the flow surface 18 and through the turbine blades 2.

FIG. 6 depicts the one of the possible support structures that could be used to constrain the wind turbine and the electric generator within the dirigible. The possible supports structures are not limited to the simple design of three lightweight ropes 23, manufactured of a lightweight fiber or other suitable material. When the assembly is fully inflated, the flow surface 18 would pull the ropes 23 taut, thereby suspending the turbine in the throat of the airship flow module. Additionally depicted is the hydrogen supply line to the turbine, to refill the inflatable turbine with lighter-than-air gas. The supply line can be made of any suitable thin-walled tubing, preferably the same as that used for the longitudinal tether 4 to minimize cost.

The three tethers are held to the earth by the ground station, which implements a winch, drum, rotor, or other appropriate design to maintain the length of the wind turbine tethers, as depicted in FIG. 13. In the case of the side tethers 3, the electrical line is wrapped around the drum 26, such that its one end is connected to the electrical generator 16 in the airship and its other end 27 supplies power to the useful loads and the control system. In the case of the longitudinal tether, the hydrogen supply line 31 and ground wire 27 are wrapped together on the drum. The ground wire is attached to the aforementioned grounding stake; meanwhile, the hydrogen supply 31 is connected to the hydrogen supply system described herein. The drum is turned by an electric motor or other similar device 29, which is controlled by the feedback control system designed to control the altitude of the wind turbine. The motor receives its power for the abovementioned control system through control wires 30.

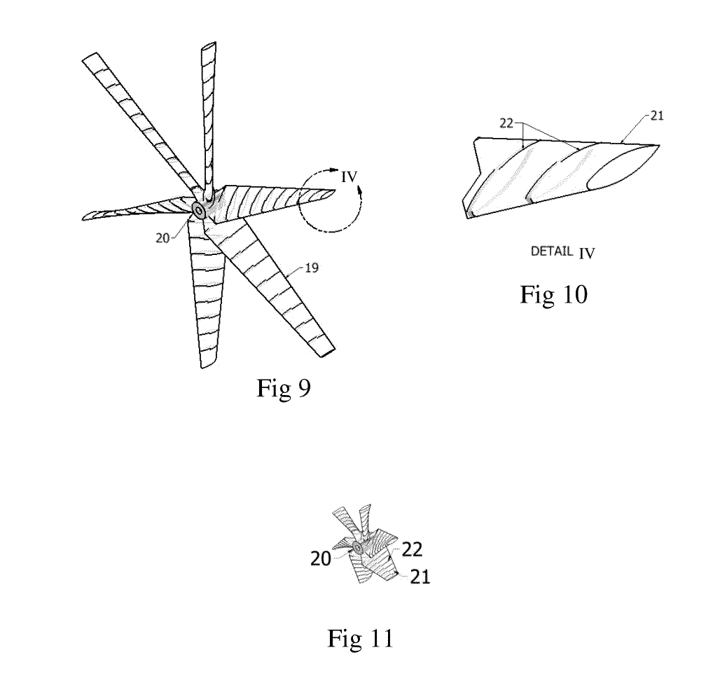

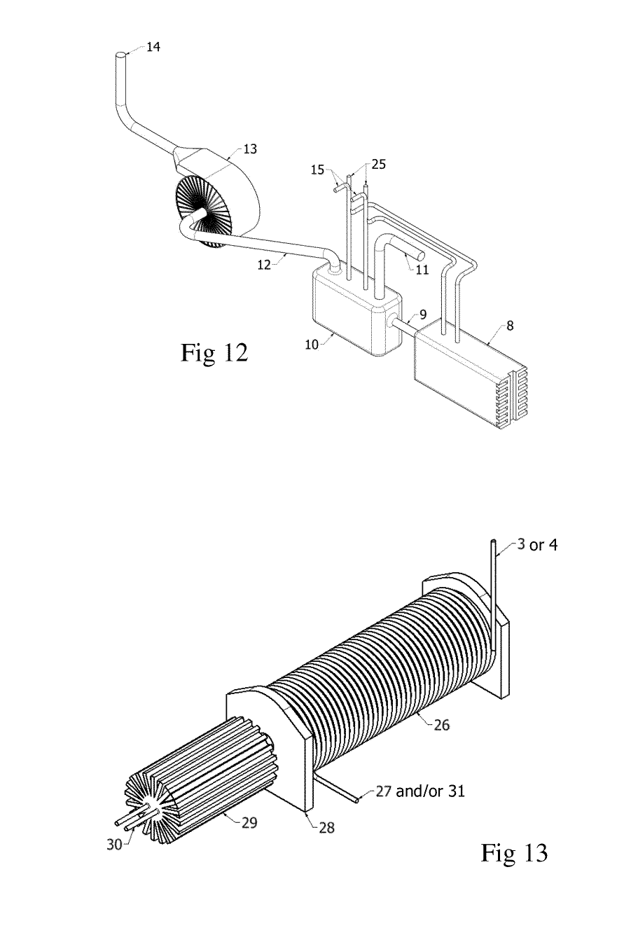

FIG. 9 depicts a possible design for the inflatable turbine used in the assembly. The design depicted comprises a high strength shaft 20, made from a lightweight metal alloy, composite, or other applicable material. The turbine rotor features at least one turbine blade 19 and can employ any number of turbine blades, as determined by designer to meet the desired performance requirements of the wind electric generation system. To ensure that the turbine blade maintains the desired airfoil cross-section, a collapsible reinforcing structure is added to the inside surface of the wind turbine blade. The turbine rotor depicted uses a thin metal or composite rib 22 over which the polymer film 21 of the wind turbine blade is stretched. This design presents the advantage of retaining its shape at high rotational speeds, while also possessing the ability to by deflated to a far smaller size, as depicted in FIG. 11. (FIGS. 9 and 11 use the same scale.) However, many alternative designs not depicted are available. One such alternative design features a semi-helical shaped spring that when in its neutral position would possess an airfoil shape, corresponding the full expansion of the turbine blade. When the turbine blade would be deflated, the spring then could be collapsed to a tenth or less of its original length. Another alternative design is depicted in U.S. Pat. No. 7,938,623. In no way are the designs discussed here intended to be limiting of the shape, reinforcements, or any other aspect of the design of the inflatable wind turbine rotor, but to give the designer an understanding of the present invention.

FIG. 12 depicts a possible system to generate the hydrogen gas used to inflate the aerodynamic shroud and the wind turbine rotor. The design depicted consists of a condenser 8, electrolysis unit 10, and compressor 13. The hydrogen generation system is powered and controlled by the control system through electrical lines 15 and 25. The condenser 8 can implement any one of many technologies to cool and condense the ambient air including a device using a vapor-compression refrigeration cycle, thermoelectric cooling using the Peltier effect, a device such as that presented in U.S. Pat. No. 8,268,030, or any other condenser. The condenser 8 then supplies the water to the electrolysis unit 10 through a small pipe 9. As yet another alternative to maximize the portability of the system and minimize the cost and weight, the condenser 8 may be omitted entirely and the hydrogen electrolysis unit 10 may be refilled by the user using a port (not depicted) located on top of the unit.

The oxygen gas generated by the unit is vented by the exhaust tube 11, where it can either be released into the atmosphere or supplied to some other system, such as breathing oxygen, compression and storage in a tank, or any other system desired by the designer or consumer. Meanwhile, the hydrogen gas is pumped into a compressor 13 through the supply tube 12, which can be manufactured of any suitable material, preferably the same used for the longitudinal tether 4. The compressor 13 compresses the hydrogen gas to the proper pressure required to inflate and maintain the pressure in the wind turbine. The hydrogen gas leaves the compressor 13 and flows into the tube 14, which is connected to the longitudinal tether inlet 31, wrapped around the drum of the winch 26. The tether 4 is then connected to the interior volume of the shroud 17 and the wind turbine rotor 2.

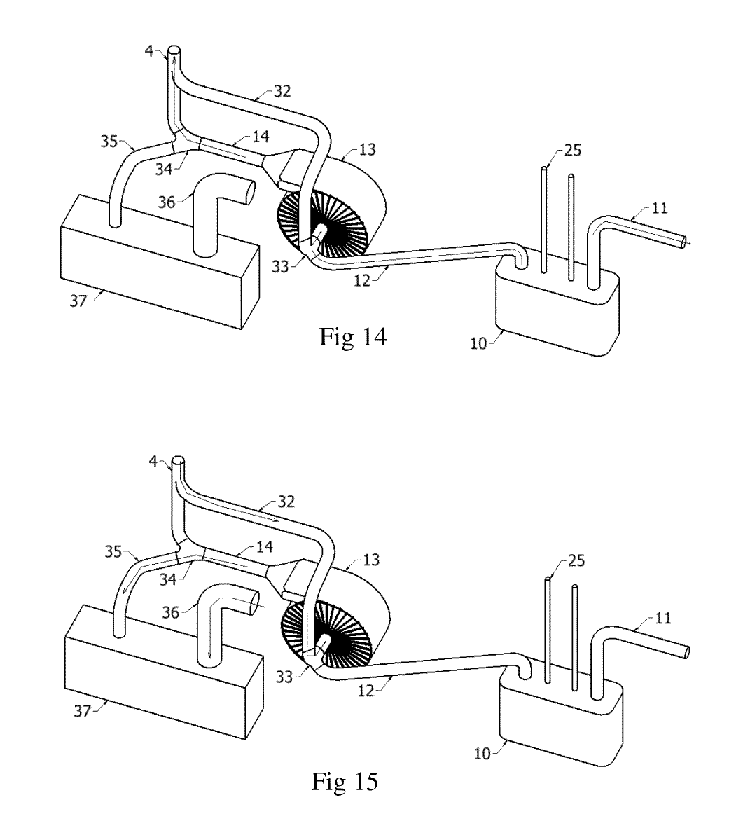

FIGS. 14 and 15 depict a possible configuration of the hydrogen generation system if the assembly were to incorporate the hydrogen recovery system to recapture the energy used to inflate the wind turbine. The setup uses the same electrolysis system and compressor described earlier. However, the system now incorporates two Y-valves, 33 and 34. Y-valve 33 selects whether the compressor 13 draws hydrogen gas from the electrolysis unit 10 or from the longitudinal tether supply line 4. Similarly, Y-valve 34 selects whether the compressed hydrogen gas will enter the tether supply line 4 or the fuel cell supply line 35 and then the fuel cell 37.

When the control system chooses to inflate the turbine, the system operates as depicted in FIG. 14 and described herein. As described before, the electrolysis unit 10 generates hydrogen gas, which is then drawn through the supply 12 to the compressor 13. The Y-valve 33 is directed so that the compressor is fed by supply line 12. The compressed gas then exits through line 14. The Y-valve 34 then directs the compressed gas into the tether supply line 4, which fills the dirigible with fresh hydrogen gas. Meanwhile, the oxygen generated by the electrolysis unit is exhausted outside the assembly.

When the user or the control system chooses to deflate the turbine, the hydrogen recovery system operates as depicted in FIG. 15. Y-valve 33 switches so that the compressor 13 draws hydrogen gas from the dirigible through the longitudinal tether 4 and into line 32, which feeds the compressor intake. The compressed gas then enters line 14 and the Y-valve 34. The Y-valve then directs the compressed gas into the supply line 35, which supplies the fuel cell 37. The fuel cell intakes ambient air through a supply tube 36 for the oxygen supply. The power generated is then delivered to then delivered to the useful loads and the control system through electrical lines (not depicted).

The entire assembly is controlled using a control system (not depicted) that controls the pressure of the hydrogen gas inside the blimp and the altitude of the blimp, as described herein. The control system includes, but is not limited to, a feedback system to control the pressure of the hydrogen gas, a feedback control system to control the rotational speed of wind turbine rotor, and a feedfoward control system that would protect the blimp from severe weather. The first feedback system would monitor the pressure of the hydrogen gas using a pressure transducer or other appropriate device that would supply data concerning the gas pressure to the control system. When the internal pressure would fall below some predetermined minimum level, the control system would activate the hydrogen generation system to re-inflate the shroud and turbine blade to the desired level. Conversely, if the internal pressure were to rise above a maximum value, the control system would activate the hydrogen recovery system to deflate the wind turbine back to the desired pressure.

A second feedback control system would ensure that the wind turbine rotor does not reach excessive rotational speeds that could damage the assembly. The system would feature some device that would sense the angular velocity of the turbine blades and relay that information to the control system. Initially the control system would let the blimp rise until the wind turbine rotor reached a minimum rotational speed, and then lock the mechanism controlling the length of the tethers. If the turbine were to reach a predetermined maximum speed, the control system would decrease the length of the tether until the blimp reached an altitude with a sufficiently low wind speed, thus protecting the wind turbine from structural damage.

Lastly, the third control system features a feedfoward system that would be activated by the user to retract the airship to ground level in case of severe weather aloft, thus protecting the system from damage that it could have encountered at high altitudes. However, if severe weather is expected at both altitude and ground level, the user-activated feedfoward control system would also deflate the aerodynamic shroud and wind turbine blade, thus minimizing any possible damage to the portable airborne wind-energy power conversion system.

The invention claimed is:

1. A portable airborne wind-energy power conversion system, wherein the portable airborne wind-energy power conversion systems may be arranged in a modular array, wherein each portable airborne wind-energy power conversion system comprises a tethered airship, a hydrogen generation system, a hydrogen recovery system, and a control system, wherein the tethered airship consists of a self-inflating horizontal-axis wind turbine rotor, an electrical generator, a self-inflating aerodynamic shroud surrounding the self-inflating wind turbine rotor, and stabilizing fins, wherein the self-inflating aerodynamic shroud has the geometry of a wind concentrator and diffuser in fluid communication with the self-inflating wind turbine rotor, wherein the self-inflating wind turbine rotor is located in the narrowest section of the self-inflating aerodynamic shroud between the concentrator and diffuser sections of the said self-inflating shroud.

2. The portable airborne wind-energy power conversion system of claim 1, wherein the self-inflating aerodynamic shroud, the self-inflating wind turbine rotor, and stabilizing fins are additionally self-deflating and the entire system is collapsible into a volume less than one tenth of its original size, so that the portable airborne wind-energy power conversion system can be easily transported, stored, or relocated, wherein the portable airborne wind-energy power conversion system can continue to produce usable power, even during the process of self-deflation.

3. The portable airborne wind-energy power conversion system of claim 2, wherein the self-inflating aerodynamic shroud is a volume of revolution with an airfoil cross-section designed to accelerate the airflow through the center of the said airship in order to maximize the power output of the portable airborne wind-energy power conversion system.

4. The portable airborne wind-energy power conversion system of claim 3, wherein the airship is directed into the oncoming wind by a set of stabilizing fins located at the exit of the diffuser section of the self-inflating aerodynamic shroud.

5. The portable airborne wind-energy power conversion system of claim 4, wherein the self-inflating wind turbine rotor, the self-inflating aerodynamic shroud, and stabilizing fins are inflated using a lighter-than-air gas, whereby the self-inflating wind turbine rotor and self-inflating aerodynamic shroud are buoyant and support the weight of the electric generator.

6. The portable airborne wind-energy power conversion system of claim 5, wherein the said lighter-than-air gas is hydrogen.

7. The portable airborne wind-energy power conversion system of claim 6, wherein the hydrogen gas used to fill the self-inflating wind turbine rotor, the self-inflating aerodynamic shroud, and stabilizing fins is generated by a hydrogen generation system comprising a condenser, an electrolysis unit, and a compressor.

8. The portable airborne wind-energy power conversion system of claim 2, wherein the airship is deflated using the hydrogen recovery system comprising the same compressor used by the hydrogen generation system and a fuel cell that recombines the hydrogen from the self-inflating wind turbine rotor, the self-inflating aerodynamic shroud, and stabilizing fins with oxygen drawn in from the ambient air, thereby recapturing the energy used to inflate the airship.

9. The portable airborne wind-energy power conversion system of claim 7, wherein the hydrogen generation system is controlled by a feedback control system that regulates the internal pressure of the self-inflating wind turbine rotor, the self-inflating aerodynamic shroud, and stabilizing fins, whereby if the internal pressure of the system drops to a predetermined minimum pressure, the said feedback control system activates the hydrogen generation system to re-inflate the tethered airship.

10. The portable airborne wind-energy power conversion system of claim 9, wherein the feedback control activates the hydrogen recovery system if the internal pressure in the airship were to exceed a predetermined maximum pressure, thereby deflating the airship to the desired pressure.

11. The portable airborne wind-energy power conversion system of claim 1, wherein the airship is tethered to the ground with at least three tethers, wherein two of the tethers are mounted to the side of the airship and the third tether mounted anywhere along the longitudinal axis of the airship.

12. The portable airborne wind-energy power conversion system of claim 11, wherein the two side tethers are electrical conductors connected to the electrical generator and the longitudinal tether comprises the compressed hydrogen gas supply line and a grounding wire.

13. The portable airborne wind-energy power conversion system of claim 6, wherein the internal and external surfaces of the self-inflating aerodynamic shroud, the self-inflating wind turbine rotor, and stabilizing fins are coated with a conductive metallic film.

14. The portable airborne wind-energy power conversion system of claim 13, wherein the conductive metallic film is connected to a ground wire and static discharge ports to dissipate static charges and protect the portable airborne wind-energy power conversion system from lightning strikes.

15. The portable airborne wind-energy power conversion system of claim 12, wherein the length of the three tethers is regulated by a winch-type apparatus that is controlled by both a feedback control system and a user-activated feedfoward control system.

16. The portable airborne wind-energy power conversion system of claim 15, wherein the feedback control system monitors the angular velocity of the self-inflating wind turbine rotor, whereby the control system extends the length of tethers, allowing the airship to ascend until the wind turbine rotor reaches a predetermined minimum rotational speed.

17. The portable airborne wind-energy power conversion system of 16, wherein the feedback control system decreases the length of tether if the wind turbine rotor reaches a predetermined maximum rotational speed, thereby reducing the altitude of the airship, and hence, the wind speed passing through the wind turbine rotor.

18. The portable airborne wind-energy power conversion system of claim 15, whereby if severe weather is forecast at high altitude, a user-activated feedfoward control system would retract the airship to ground level by retracting the three tethers to their minimum length.

19. The portable airborne wind-energy power conversion system of 18, wherein the user-activated feedfoward control system would additionally fully deflate the airship using the hydrogen recovery system if severe weather were expected both at altitude and at ground level.
